(19) United States
(12) Patent Application Publication
(10) Pub. No.: US 2024/0235966 A9
(43) Pub. Date: Jul. 11, 2024

(54) INFERRING APPLICATION EXPERIENCE FROM DNS TRAFFIC PATTERNS

(71) Applicant: Cisco Technology, Inc., San Jose, CA (US)

(72) Inventors: Michal Wladyslaw Garcarz, Krakow (PL); Jean-Philippe Vasseur, Saint Martin d'Uriage (FR)

(21) Appl. No.: 17/971,273

(22) Filed: Oct. 21, 2022

(51) Int. Cl. H04L 43/026; H04L 43/062; H04L 61/4511

(52) U.S. Cl. CPC H04L 43/026; H04L 43/062; H04L 61/4511

(57) ABSTRACT

In one embodiment, a device obtains telemetry data regarding Domain Name System (DNS) traffic in a network. The device associates, based on the telemetry data, the DNS traffic with a particular online application. The device identifies a traffic pattern of the DNS traffic associated with the particular online application. The device makes, based on the traffic pattern, a determination that an application experience of one or more users of the particular online application is degraded.

### TECHNICAL FIELD

The present disclosure relates generally to computer networks, and, more particularly, to inferring application experience from Domain Name System (DNS) traffic patterns.

### BACKGROUND

With the recent evolution of machine learning, predictive failure detection and proactive routing in a network now becomes possible through the use of machine learning techniques. For instance, modeling the delay, jitter, packet loss, etc. for a network path can be used to predict when that path will violate the service level agreement (SLA) of the application and reroute the traffic, in advance. However, doing so is also not without cost, as needlessly rerouting application traffic can also negatively impact the application experience of a user.

Testing has shown that network metrics are often poor proxies for the true, subjective application experience of a user. For instance, certain audio codecs for voice applications are now resilient to packet loss of up to 30%, meaning that significant path degradation may not even be noticeable by the user. In addition, simply garnering user feedback at the end of their application session by asking the user to rate their videoconference experience on a scale of 0-5 stars) provides little useful information with respect to predicting when the application experience will be degraded, as the network conditions that led to the user rating their experience as ‘poor’ may have occurred at any point in time during their call.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for inferring application experience from Domain Name System (DNS) traffic patterns;

FIGS. 6A-6B illustrate example DNS traffic patterns associated with a particular application; and

FIG. 7 illustrates an example simplified procedure for inferring application experience from DNS traffic patterns.

### DESCRIPTION OF EXAMPLE EMBODIMENTS

### Overview

According to one or more embodiments of the disclosure, a device obtains telemetry data regarding Domain Name System (DNS) traffic in a network. The device associates, based on the telemetry data, the DNS traffic with a particular online application. The device identifies a traffic pattern of the DNS traffic associated with the particular online application. The device makes, based on the traffic pattern, a determination that an application experience of one or more users of the particular online application is degraded.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

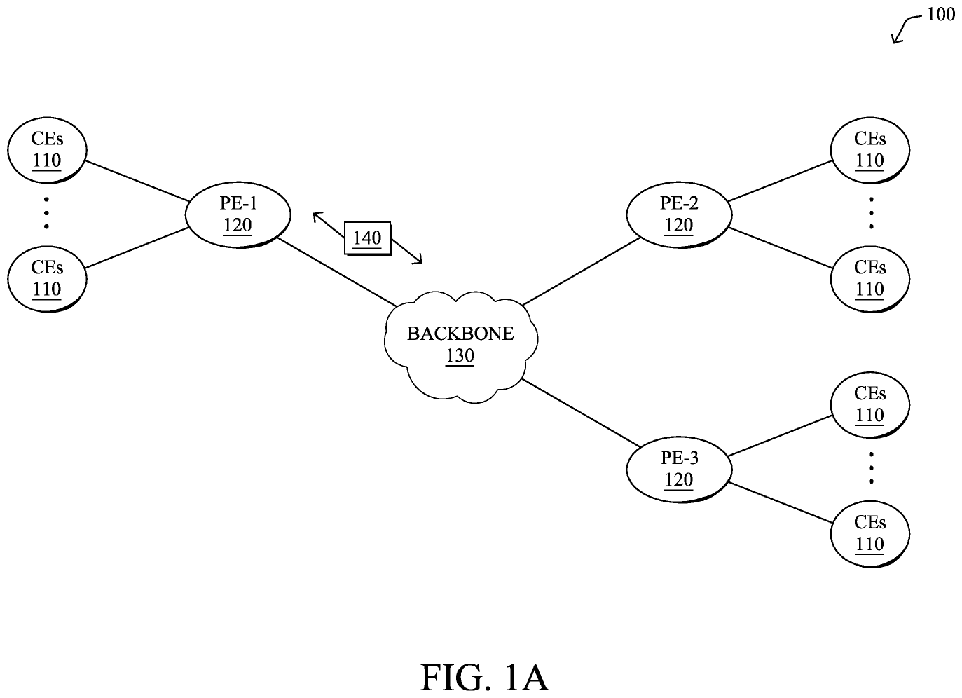

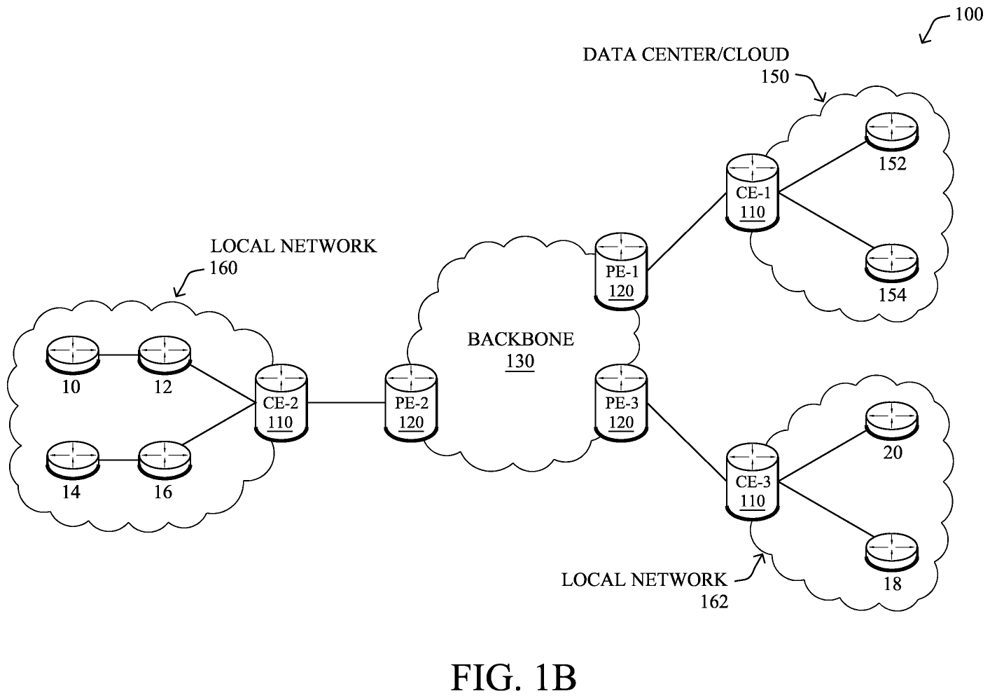

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

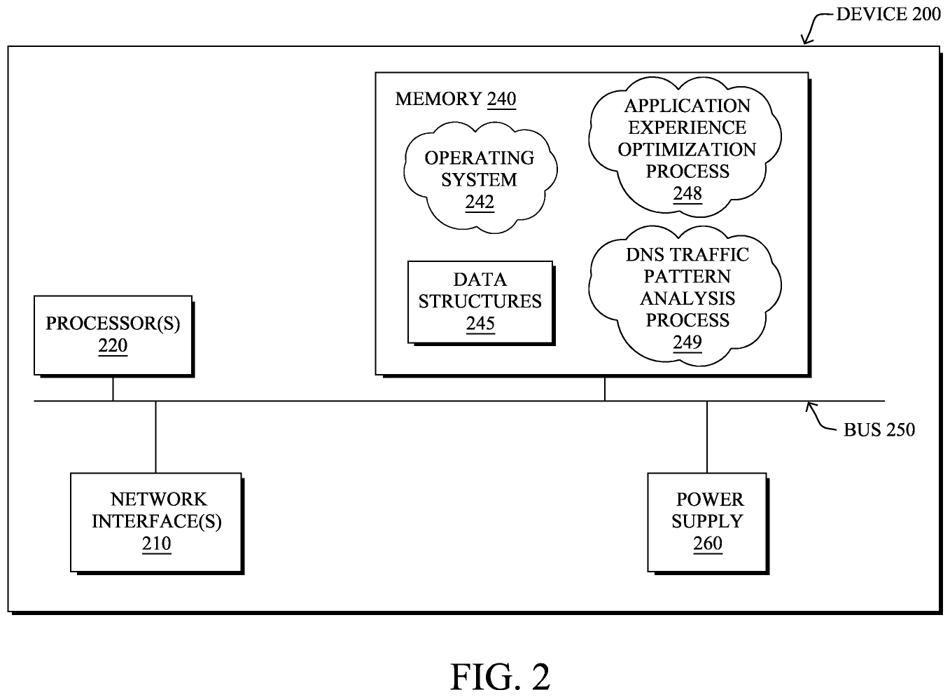

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an application experience optimization process 248 and/or DNS traffic pattern analysis process 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, application experience optimization process 248 and/or DNS traffic pattern analysis process 249 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc.

In various embodiments, as detailed further below, application experience optimization process 248 and/or DNS traffic pattern analysis process 249 may include computer executable instructions that, when executed by processor(s) 220, cause device 200 to perform the techniques described herein. To do so, in some embodiments, application experience optimization process 248 and/or DNS traffic pattern analysis process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, application experience optimization process 248 and/or DNS traffic pattern analysis process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that application experience optimization process 248 and/or DNS traffic pattern analysis process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

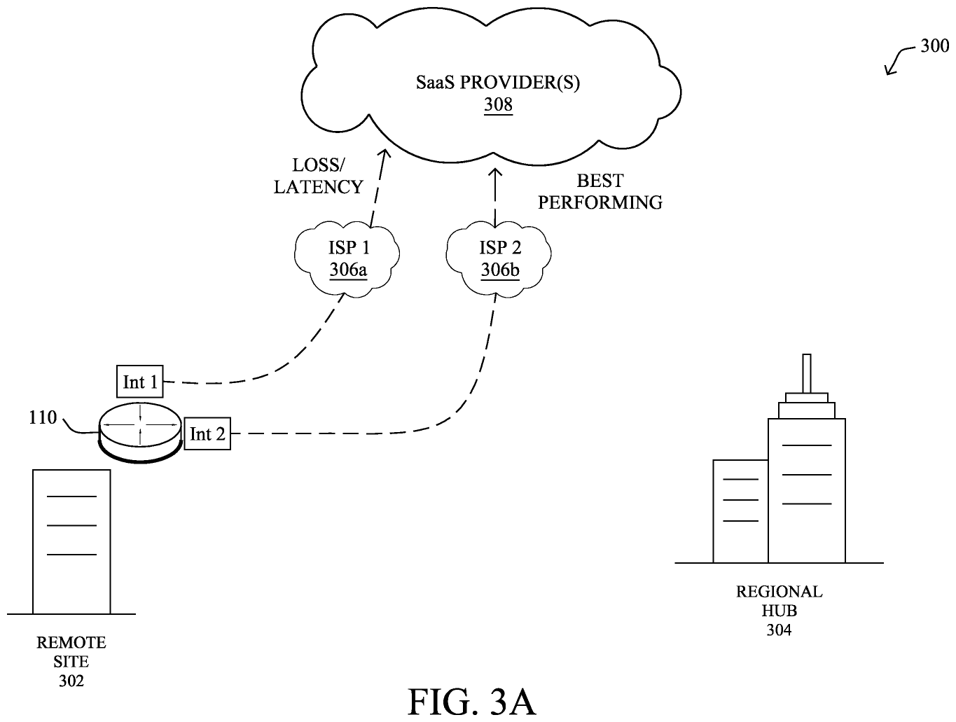

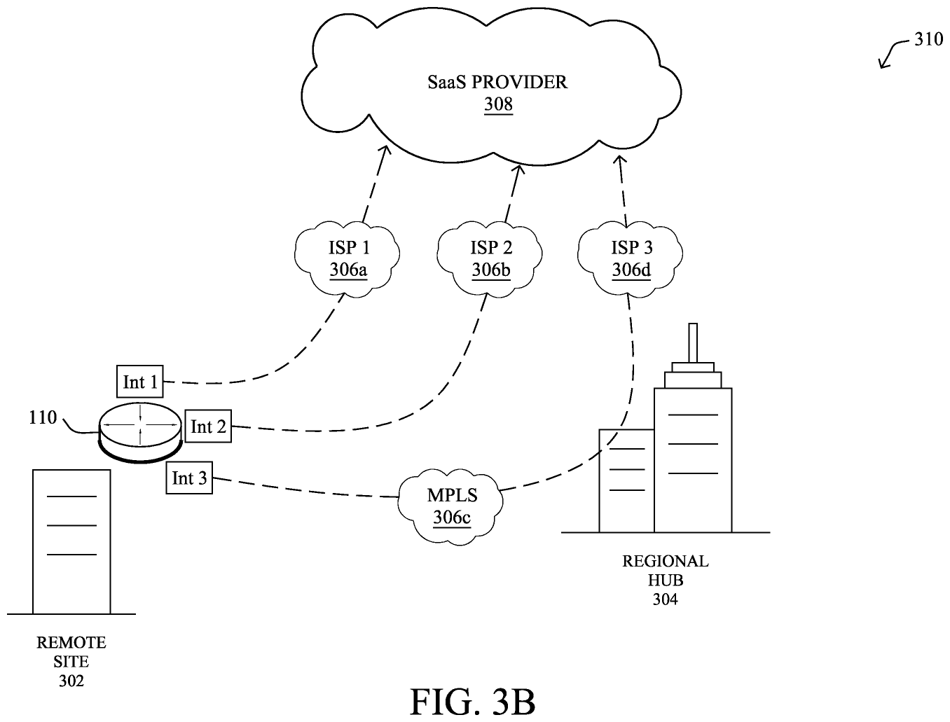

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

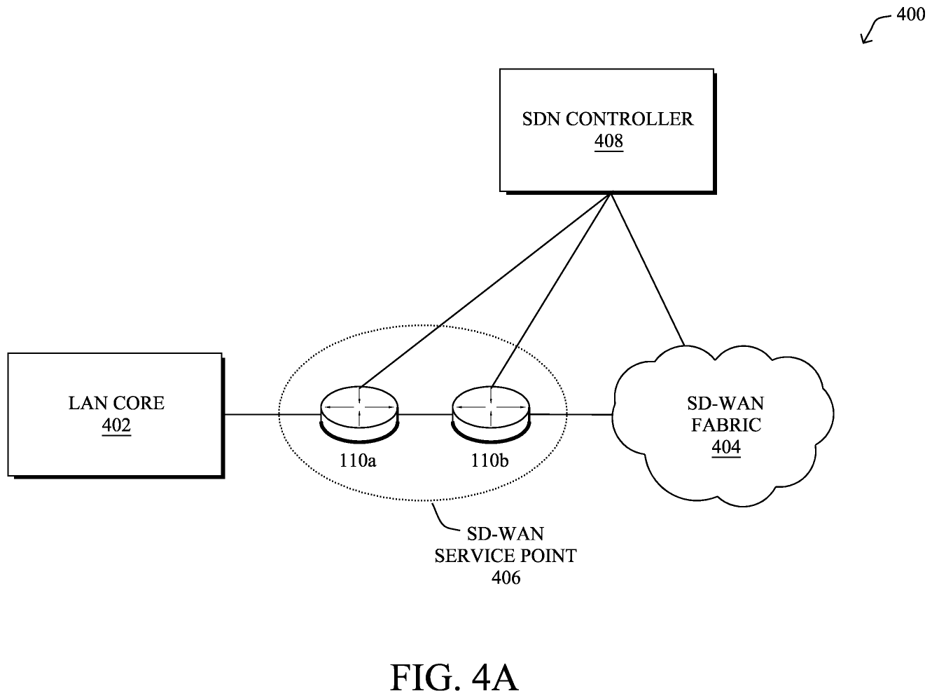

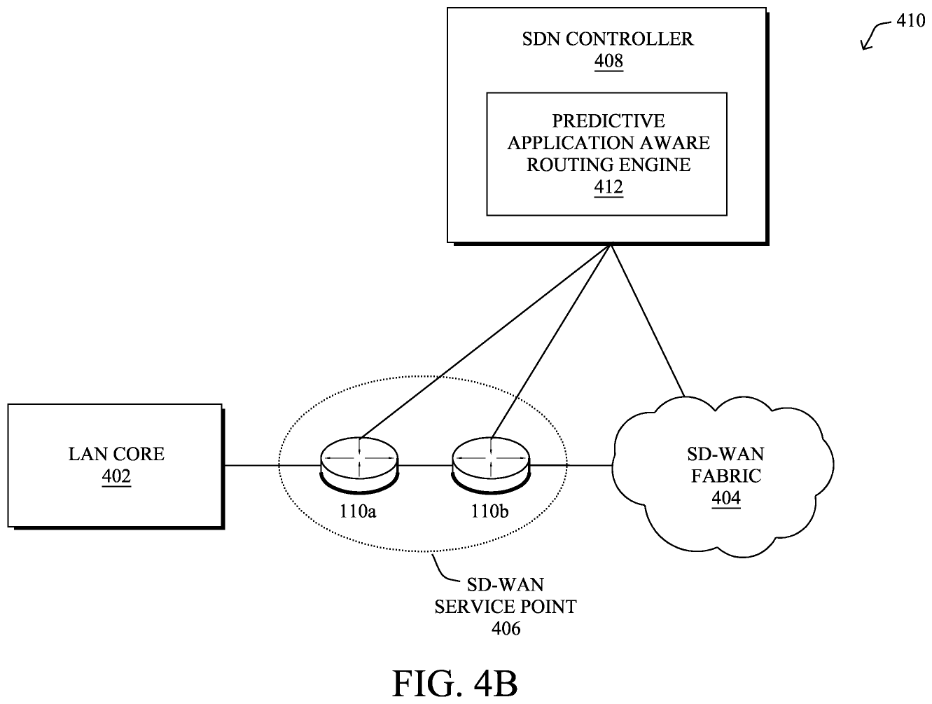

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MLPS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions,
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The tem ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of application experience optimization process 248 and/or DNS traffic pattern analysis process 249). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy for actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As noted above, predictive networking engines, such as predictive application aware routing engine 412, seek to select the best path from among a plurality of paths P₁, P₂, . . . , P_{N} such that end users of a given online application, either SaaS-delivered (e.g., WebEx, Zoom, O365, Salesforce, SAP, etc.) or datacenter-hosted (and monitored via tools such as Datadog, AppDynamics, etc.) have the best experience possible. In the context of SD-WAN, these paths may be probed for liveness and basic path QoS metrics (e.g., loss, latency, jitter, throughput, etc.) at the network level (L3), typically using technologies such as Bidirectional Forwarding Detection (BFD) probing.

However, actively probing the QoS metrics of all of the possible network paths, for each possible combination of clients and applications, does not scale well in the real world. Consequently, simply relying on application telemetry techniques and/or network analytics for purposes of inferring the application experience (i.e., QoE) of a given online application.

—Inferring Application Experience from DNS Traffic Patterns—

The techniques introduced herein propose using DNS processing times as a proxy for the application experience/QoE of users of an online application, as most online applications perform a series of DNS requests when loading a page. In some aspects, DNS logs may be obtained (e.g., from OpenDNS, other DNS services, etc.). In turn, statistical and/or machine learning techniques can be used to identify anomalous traffic patterns, which could indicate degraded application experience for users of the application. In further aspects, the system may also seek feedback from an expert regarding the anomalous patterns, so as to adjust and improve the task of raising anomalies that indicate poor application experience/QoE.

Illustratively, the techniques described herein may be performed by hardware, software, and/or firmware, such as in application experience optimization process 248 and/or DNS traffic pattern analysis process 249, which may include computer executable instructions executed by the processor 220 (or independent processor of interfaces 210) to perform functions relating to the techniques described herein.

Specifically, according to various embodiments, a device obtains telemetry data regarding Domain Name System (DNS) traffic in a network. The device associates, based on the telemetry data, the DNS traffic with a particular online application. The device identifies a traffic pattern of the DNS traffic associated with the particular online application. The device makes, based on the traffic pattern, a determination that an application experience of one or more users of the particular online application is degraded.

Operationally, the techniques herein are based on two main assumptions:
1. Most online applications, especially those that are web-based, perform operations in a sequential manner. This means that certain operations are inter-dependent on one another and any performance issues or delays will also cause all dependent resources and operations to also be delayed.
2. Most online applications have also been observed to have unique DNS traffic patterns associated with one another.

For instance, an example online application may perform the following operations, sequentially:
1. Phase 1: Authenticate a user logging into the application, potentially with a redirection to a multifactor authentication (MFA) service, such as Duo Security or the like.
2. Phase 2: Once the user is authenticated, retrieve the list of available tenants (e.g., by making an API call using DNS). Note that this operation depends on the previous step, as different users may be authorized to use different sets of tenants.
3. Phase 3: Use the first active tenant and display tenant-specific metrics on the main page of the application to the user. This means that the system will make yet another API call using DNS, to retrieve the tenant-specific metrics. Since this call depends on the list of tenants to which the user has access, this operation also depends on the operation immediately above.

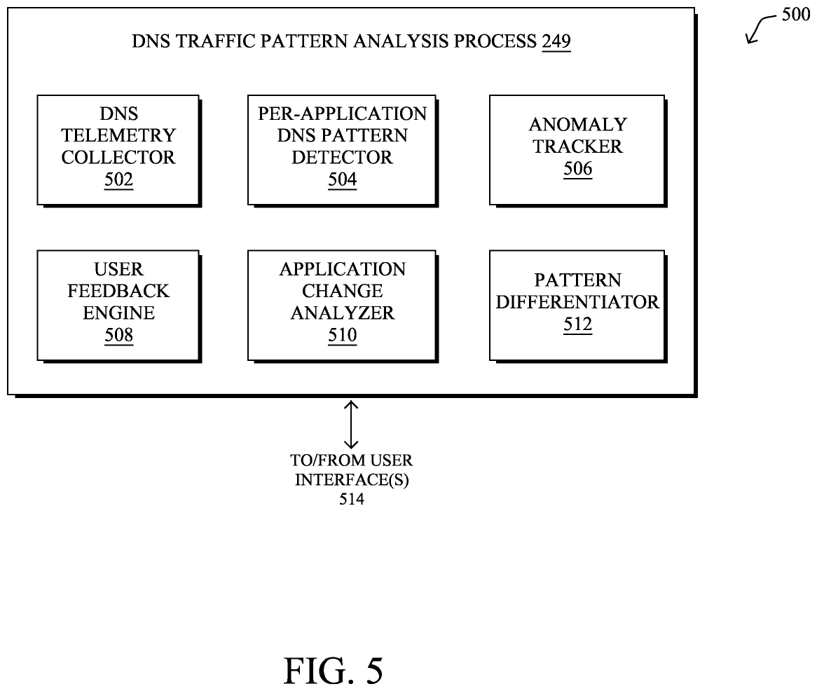

FIG. 5 illustrates an example architecture 500 for using chatbots to collect direct user feedback on application experience, according to various embodiments. At the core of architecture 500 is DNS traffic pattern analysis process 249, which may be executed by a controller for a network, a networking device, or another device in communication therewith. For instance, DNS traffic pattern analysis process 249 may be executed by a controller for a network (e.g., SDN controller 408 in FIGS. 4A-4B), a particular networking device in the network (e.g., a router, etc.), another device or service in communication therewith, or the like. In some embodiments, for instance, DNS traffic pattern analysis process 249 may be used to implement a predictive application aware routing engine, such as predictive application aware routing engine 412, or another supervisory service for the network. In other embodiments, application DNS traffic pattern analysis process 249 may be used to implement a reactive routing approach in the network.

As shown, DNS traffic pattern analysis process 249 may include any or all of the following components: a DNS telemetry collector 502, a per-application DNS pattern detector 504, an anomaly tracker 506, a user feedback engine 508, an application change analyzer 510, and/or a pattern differentiator 512. As would be appreciated, the functionalities of these components may be combined or omitted, as desired (e.g., implemented as part of DNS traffic pattern analysis process 249). In addition, these components may be implemented on a singular device or in a distributed manner, in which case the combination of executing devices can be viewed as their own singular device for purposes of executing DNS traffic pattern analysis process 249.

In various embodiments, DNS telemetry collector 502 may be responsible for obtaining telemetry data from the network regarding DNS traffic in the network. For instance, DNS telemetry collector 502 may receive DNS logs from one or more DNS servers/services. Other examples of DNS logs that DNS telemetry collector 502 may obtain could include logs from a security service (e.g., Cisco Umbrella has visibility over approximately 5% of all DNS traffic, globally), Amazon Web Services (AWS) Route53 logs, or the like. Regardless of the source of the logs, DNS telemetry collector 502 may store the DNS telemetry in a normalized data lake.

Per-application DNS pattern detector 504 may be responsible for identifying the DNS traffic pattern(s)/profile(s) from the DNS telemetry obtained by DNS telemetry collector 502 on a per-application basis, according to various embodiments. To that end, per-application DNS pattern detector 504 may train an anomaly detection model or other machine learning or statistical model, to learn the DNS traffic patterns for a particular online application. In a first embodiment, per-application DNS pattern detector 504 may train the model globally with a single model for all users/clients of the application, regardless of their location. In another embodiment, per-application DNS pattern detector 504 may instead train multiple models, such as per-user/client models, models for different geographic locations, or the like, which may be required if there is a broad range of QoE across the full user base of the application. In yet another embodiment, the model may be specific to the web page (indeed, each web page will have a different pattern of DNS queries) or for a specific action triggered by the user (e.g., clicking on a certain button, etc.).

A simple approach may consist in per-application DNS pattern detector 504 computing the statistical distributions of the DNS queries processing time and flag any as abnormal that have a Zscore greater than a predefined threshold (e.g., Zscore>3). A more sophisticated approach may be for per-application DNS pattern detector 504 to predict the DNS processing time as a function of the application, user location, etc. For instance, per-application DNS pattern detector 504 could perform regression on the P90 percentile with an algorithm such as Gradient Boosted Tree (GBT) that predicts, for a given user, application (and potentially visited Web page), etc., the P90 for the DNS processing time and then flag any anomalous DNS traffic patterns associated with the application. In another embodiment, per-application DNS pattern detector 504 could leverage isolation forests for the anomaly detection. Of course, per-application DNS pattern detector 504 could leverage other types of statistical and/or machine learning models, to detect anomalous DNS traffic patterns, as well.

In some embodiments, per-application DNS pattern detector 504 may provide information regarding its trained model to one or more user interfaces 514, for review by an expert user/administrator. This may allow the expert to visually inspect the validity of the raised anomalies, the various DNS traffic patterns (e.g., the expected/baseline pattern, an observed pattern, etc.).

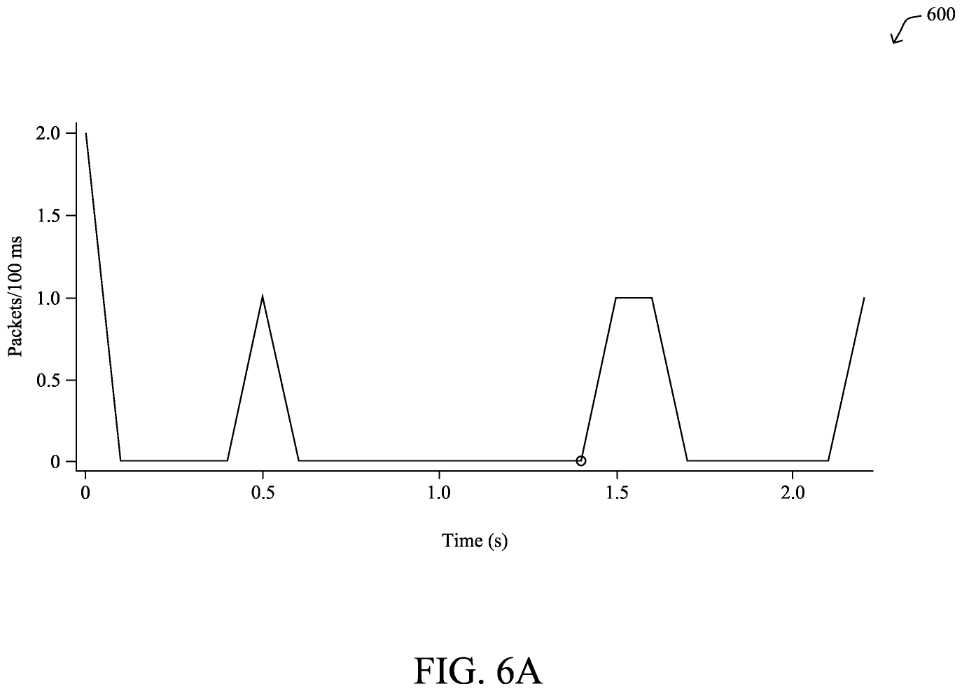

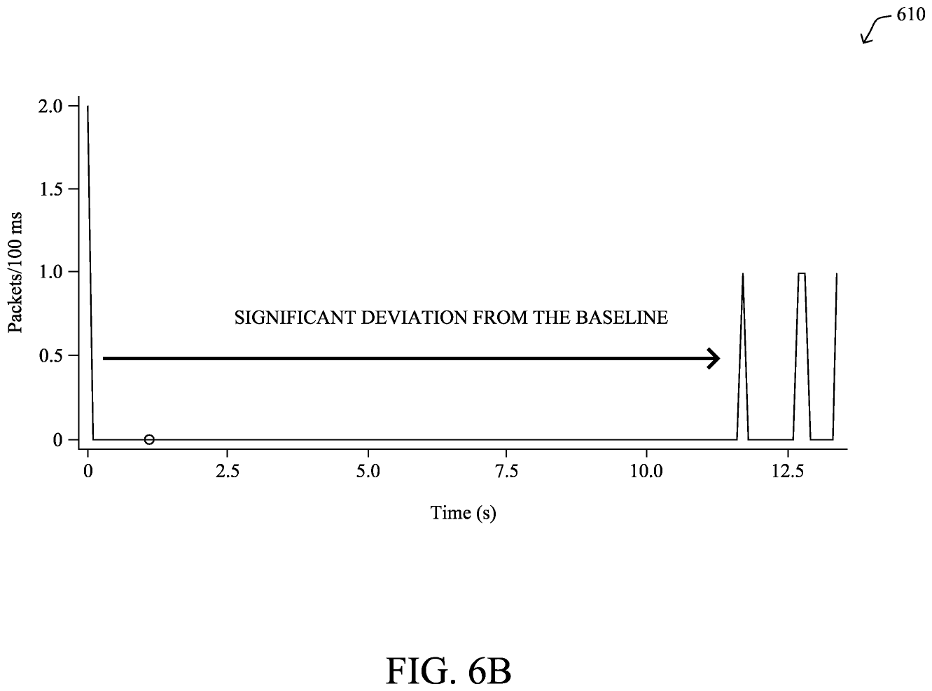

By way of example, FIGS. 6A-6B illustrate example DNS traffic patterns associated with a particular application. More specifically, FIG. 6A shows a plot 600 of the number of DNS packets over time sent by a client of a particular online application, such an application that performs the three example phases of operations described previously. From plot 600, it can be seen that the DNS requests sent between Phase 2 and Phase 3 operations are spaced out by less than two seconds.

FIG. 6B shows an example plot 610 showing an anomalous traffic pattern for the same application. Similar to plot 600, plot 610 also shows the number of DNS packets over time for the same application. Here, however, there is an almost eleven second delay that corresponds to Phase 2 being delayed (e.g., fetching/processing the tenant list). This is a significant deviation from the baseline DNS traffic profile in FIG. 6A and may be assumed to be an indication that the user experience of the user(s) of the application has also been degraded (e.g., causing a user to wait an exceedingly long time to complete an action or other operation within the application).

Referring again to FIG. 5, per-application DNS pattern detector 504 may leverage any number of different techniques to train its model, so as to make sure that the trained dataset does not include abnormal DNS query times. To do so, a network probing mechanism (e.g., Thousand Eyes, etc.) could be leveraged to automate the process of collecting the telemetry data needed to train the model to recognize the DNS traffic pattern(s) of the application. In other cases, application clients could be executed at various points in the network, to observe their DNS traffic patterns, rather than observing the DNS traffic of actual users/clients of the application. Regardless, note that this collection can also be done across different sets of web domains, as well (e.g., Office 365 PowerPoint typically queries multiple, different DNS domains).

In various embodiments, anomaly tracker 506 may be responsible for inferring from the DNS traffic pattern associated with an online application whether its application experience is degraded. In other words, anomaly tracker 506 may determine whether a particular DNS traffic pattern associated with the application is anomalous (e.g., different from its baseline pattern by a threshold amount). Preferably, the DNS pattern being analyzed by anomaly tracker 506 is a live pattern (or with a slight delay), based on the currently available DNS telemetry logs from DNS telemetry collector 502. There are multiple ways as to how the current DNS pattern could be built out of the live DNS logs. For instance, such a pattern could focus on a single user/flow, on many users using the same application (different aggregation levels), or even country wise. Such a pattern might have also multiple representations, such as the distribution of DNS queries for different domains (which one was more popular, which less) and/or time series (showing all DNS queries in time), both of those could be used when comparing to similar baseline pattern (e.g., as computed by per-application DNS pattern detector 504).

In various embodiments, user feedback engine 508 may be responsible for processing and validating anomalies raised by anomaly tracker 506 using user feedback from one or more user interfaces 514. More specifically, if anomaly tracker 506 detects an anomalous DNS traffic pattern associated with a particular online application, user feedback engine 508 may send information regarding the anomaly to one or more user interfaces 514 for review by one or more expert users/administrators. In some embodiments, they may also be asked to validate that the detected anomalous pattern is actually indicative of degraded user experience. If the expert user(s) determine that the pattern is not actually impactful on the user experience, this feedback may be used by user feedback engine 508 to tune the parameters of the anomaly detection model of anomaly tracker 506. For example, based on the feedback, user feedback engine 508 may increase the Zscore threshold, set a percentile threshold to a different value (e.g., P95 instead of P90), or the like. This feedback loop allows the hyperparameters to be adjusted, dynamically. Conversely, if QoE degradation is confirmed, it may also be reported to the expert user/administrator via one or more user interfaces 514, as well.

In some embodiments, additional logic could also be used, such as heuristics, to decide whether an anomaly alert is impactful on the application experience or not. For instance, user feedback engine 508 may filter out anomaly alerts from certain users, locations, applications, etc. In a further embodiment, user feedback engine 508 may also send the anomaly alerts to a network security system for further analysis, to determine whether the anomalous DNS traffic pattern is the result of a malicious attack and not some other underlying issue.

Application change analyzer 510 may be responsible for tracking the anomalies detected by anomaly tracker 506 and/or alerts raised by user feedback engine 508, to determine whether the anomalous DNS traffic pattern is due to a permanent change to the online application. For instance, if a new version of the application was recently released, this may result in it exhibiting a very different baseline DNS traffic pattern than in the past and the new pattern does not indicate a degraded user experience. In such cases, application change analyzer 510 may trigger any or all of the previously described components of DNS traffic pattern analysis process 249 to recompute a new baseline and anomaly detection model for the application.

Optionally, DNS traffic pattern analysis process 249 may also include pattern differentiator 512, which is responsible for aiding in differentiating DNS traffic patterns per application built at different phases/actions within the application. For instance, in the case of an application having the Phase 1-3 operations described above, this may result in an initial DNS traffic pattern that is very similar for all of its users, as each user will go through a similar login process. However, based on the analysis by pattern differentiator 512, later phases of operation could also have their own DNS traffic patterns, due to the different activities that users may perform within the application (e.g., clicking a specific action, etc.). Thus, pattern differentiator 512 may analyze the DNS traffic (and potentially the HTTP traffic of the application, as well), to differentiate between the different potential DNS patterns that the application may exhibit. In turn, a collection of different baseline DNS traffic patterns could be constructed and used to perform the anomaly detection.

As would be appreciated, DNS traffic pattern analysis process 249 may operate in conjunction with application experience optimization process 248, so that any inferred degradation of the application experience can be rectified, automatically. For instance, if DNS traffic pattern analysis process 249 detects an anomalous DNS traffic pattern being exhibited by one or more clients of the application, it may signal application experience optimization process 248 to perform a reroute of the application traffic of those users (e.g., by switching their connections from cable to cellular, etc.).

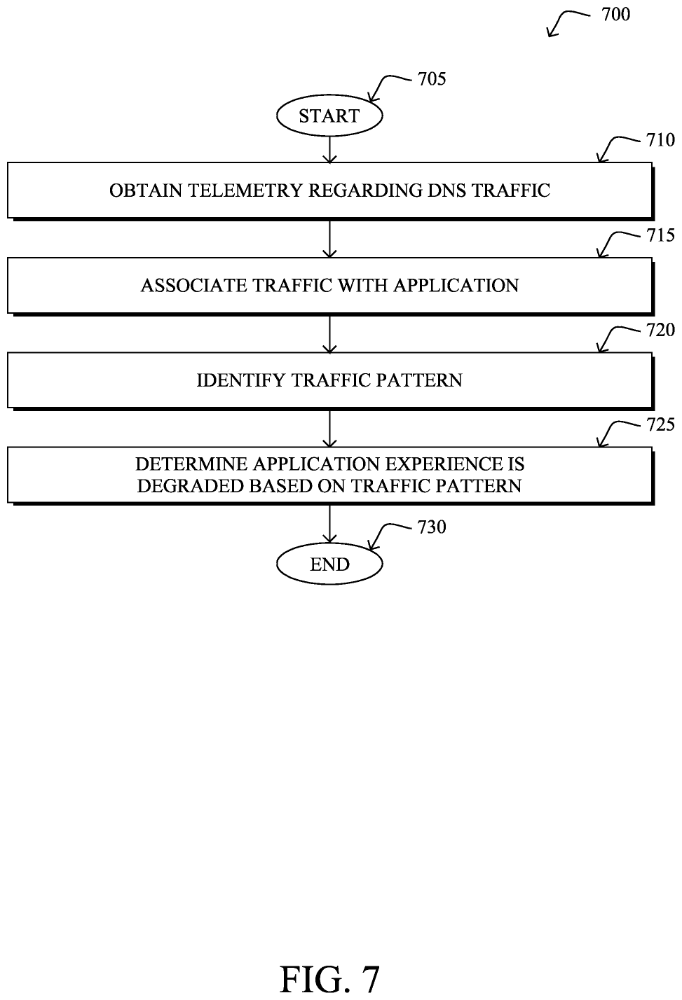

FIG. 7 illustrates an example simplified procedure 700 (e.g., a method) for inferring application experience from DNS traffic patterns, in accordance with one or more embodiments described herein. For example, a non-generic, specifically configured device (e.g., device 200), such as controller for a network (e.g., an SDN controller, a cloud-based device, etc.), an edge router, or other device in communication therewith, may perform procedure 700 by executing stored instructions (e.g., application experience optimization process 248 and/or DNS traffic pattern analysis process 249). The procedure 700 may start at step 705, and continues to step 710, where, as described in greater detail above, the device may obtain telemetry data regarding DNS traffic in a network. In one embodiment, the DNS traffic comprises DNS requests sent by clients of the particular online application.

At step 715, as detailed above, the device may associate, based on the telemetry data, the DNS traffic with a particular online application. In one embodiment, the telemetry data may be from a specific geographic location (e.g., city, metropolitan area, state, country, etc.).

At step 720, the device may identify a traffic pattern of the DNS traffic associated with the particular online application, as described in greater detail above. In some embodiments, the device may also provide an indication of the traffic pattern for display by a user interface. In a further embodiment, the device may also receive an indication from a user interface that the traffic pattern is considered normal and not indicative of the application experience being degraded. In yet another embodiment, the device may also associate the traffic pattern with a particular action performed within particular online application.

At step 725, as detailed above, the device makes, based on the traffic pattern, a determination that an application experience of one or more users of the particular online application is degraded. In some embodiments, the device may do so by comparing the traffic pattern to a baseline pattern of DNS traffic associated with the particular online application. In other embodiments, the device may do so by applying an anomaly detector to the traffic pattern. In one embodiment, the anomaly detector determines that timing between DNS queries in the DNS traffic is anomalous.

In additional, embodiments, the device may also cause application traffic associated with the one or more users to be rerouted in the network, based on the determination. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for inferring application experience from DNS traffic patterns, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, telemetry data regarding Domain Name System traffic in a network;
associating, by the device and based on the telemetry data, the Domain Name System traffic with a particular online application;
identifying, by the device, a traffic pattern of the Domain Name System traffic associated with the particular online application;
making, by the device and based on the traffic pattern, a determination that an application experience of one or more users of the particular online application is degraded; and
causing, by the device and based on the determination, application traffic associated with the one or more users to be rerouted in the network by using a different network connection.

2. The method as in claim 1, wherein the Domain Name System traffic comprises Domain Name System requests sent by clients of the particular online application.

3. The method as in claim 1, wherein making the determination comprises:
comparing the traffic pattern to a baseline pattern of Domain Name System traffic associated with the particular online application.

4. The method as in claim 1, further comprising:
providing an indication of the traffic pattern for display by a user interface.

5. (canceled)

6. The method as in claim 1, wherein making the determination comprises:
applying an anomaly detector to the traffic pattern.

7. The method as in claim 6, wherein the anomaly detector determines that timing between Domain Name System queries in the Domain Name System traffic is anomalous.

8. The method as in claim 1, wherein the telemetry data is from a specific geographic location.

9. The method as in claim 1, further comprising:
receiving, at the device, an indication from a user interface that the traffic pattern is considered normal and not indicative of the application experience being degraded.

10. The method as in claim 1, further comprising:
associating the traffic pattern with a particular action performed within particular online application.

11. An apparatus, comprising:
one or more network interfaces;
a processor coupled to the one or more network interfaces and configured to execute one or more processes; and
a memory configured to store a process that is executable by the processor, the process when executed configured to:
obtain telemetry data regarding Domain Name System traffic in a network;
associate, based on the telemetry data, the Domain Name System traffic with a particular online application;
identify a traffic pattern of the Domain Name System traffic associated with the particular online application;
make, based on the traffic pattern, a determination that an application experience of one or more users of the particular online application is degraded; and
cause, based on the determination, application traffic associated with the one or more users to be rerouted in the network by using a different network connection.

12. The apparatus as in claim 11, wherein the Domain Name System traffic comprises Domain Name System requests sent by clients of the particular online application.

13. The apparatus as in claim 11, wherein the apparatus makes the determination by:
comparing the traffic pattern to a baseline pattern of Domain Name System traffic associated with the particular online application.

14. The apparatus as in claim 11, wherein the process when executed is further configured to:
provide an indication of the traffic pattern for display by a user interface.

15. (canceled)

16. The apparatus as in claim 11, wherein the apparatus makes the determination by:
applying an anomaly detector to the traffic pattern.

17. The apparatus as in claim 16, wherein the anomaly detector determines that timing between Domain Name System queries in the Domain Name System traffic is anomalous.

18. The apparatus as in claim 11, wherein the telemetry data is from a specific geographic location.

19. The apparatus as in claim 11, wherein the process when executed is further configured to:
receive an indication from a user interface that the traffic pattern is considered normal and not indicative of the application experience being degraded.

20. A tangible, non-transitory, computer-readable medium storing program instructions that cause a device to execute a process comprising:
obtaining, by the device, telemetry data regarding Domain Name System traffic in a network;
associating, by the device and based on the telemetry data, the Domain Name System traffic with a particular online application;
identifying, by the device, a traffic pattern of the Domain Name System traffic associated with the particular online application;
making, by the device and based on the traffic pattern, a determination that an application experience of one or more users of the particular online application is degraded; and
causing, by the device and based on the determination, application traffic associated with the one or more users to be rerouted in the network by using a different network connection.
